(19) United States
(12) Patent Application Publication
(10) Pub. No.: US 2001/0034622 A1
(43) Pub. Date: Oct. 25, 2001

(54) Hub based service delivery method and system

(76) Inventor: Mark A. Davis, Coppell, TX (US)

Correspondence Address: William N. Hulsey III, Hughes & Luce, L.L.P., Suite 2800, 1717 Main Street, Dallas, TX, 75201, US

(21) Appl. No.: 09/832,324

(22) Filed: Apr. 9, 2001

Related U.S. Application Data
(60) Provisional application No. 60/195,685, filed on Apr. 7, 2000.

(51) Int. Cl. G06F 17/60

(52) U.S. Cl. 705/4; 705/26

(57) ABSTRACT

Aspects of the invention are found in a hub-to-hub business network, the network characterized by having modifiable hubs in each layer. A central service directs the operation. A broker or client can solicit quotes from providers through the central network server. Additionally, the central network hub provides web access for clients and brokers, intranet capabilities for the respective employees and entities, and ASP functionality. The central server may be partitioned to allow for secure communication among individuals or groups of individuals. Further, a provider may be able to directly interface with client employees through such ASP, web hosting, and intranet functionalities.

### RELATED APPLICATIONS

This application claims priority of U.S. patent application, Ser. No. 60/195,685, filed Apr. 7, 2001 entitled: “Modifiable Hub-to-Hub Business Method and System”, and is incorporated herein by reference in its entirety.

### BACKGROUND

1. Field of the Invention

The present invention generally relates to an online hub-to-hub backbone support system. In particular, the present invention relates to an online dynamically modifiable kiosk system wherein providers, brokers, and customers are provided with an online backbone to support a unique storefront for the brokers and integrated communication and application service providing mechanism for the broker, client, and employees thereof.

2. Description of Prior Art

Many typical businesses use an interconnected network, such as the Internet, for a variety of business-to-business and intra-business applications. Such usage may entail a direct communication with an entity that provides goods and service, or a provider, or in the case of a service provider. In the opposite direction, a networked connection allows a provider direct communication with key individuals within an organization. In this name, the network connection may be used to make certain data, such as forms, schedules, and necessary information available to both the broker companies' individual employees to their clients through client contacts, or to the individual employees within the customer's organization.

Additionally, an interconnected network is a convenient mechanism for the delivery of application software providers' (ASP) content and service applications. In this case, a provider may allow an end user to run a variety of applications in an ASP mode. In this manner, the functional application or data is stored or performed at a remote location, and the results are communicated to an end-user located somewhere in an interconnected network. As such, space is saved on an individual computer's hard drive or server that would otherwise be used to store, manipulate, operate and implement a particular software suite for an individual or organization.

Interconnected networks may typically be used for the transmission of personal messages between individuals. This may take place in the context of a chat board, bulletin board, email, or an instant message. Further, these interconnected network connections may or may not be secure, so that individuals within particular groups may communicate with one another not knowing if it is done in a secure manner.

However, in some businesses, the cost of buying and maintaining network switching equipment, routes and servers is prohibitive for the organization to implement these functions for its employees due to size and cost considerations. The expense and work necessary to maintaining a storefront operation in an interconnected network environment may be prohibitive to these smaller entities in terms of creating and implementing a particular storefront “look and feel.” In short, the capital costs and effort associated with building and maintaining an Internet presence with the functionalities of a localized network is a drawback to maintaining online presence.

Further, an Internet clearinghouse may be used in the context of submitting bids and proposals to individuals. The Internet concept may be expanded to use the concept of pooling or aggregation to achieve economies of scale. In this manner, the Internet may be used as a “meeting-place” wherein one entity may search for an aggregation of goods and services at a common location, compare the prices, and make business decisions based upon prices at that aggregation location.

Typically, however, each of these functions is performed in discrete steps throughout the interconnected world. Each individual technical function must be searched out and implemented. As such, an individual or entity needs to maintain the technological functionality thereof in its place or places of business. In this manner the functionalities described herein are not linked in increase of fashions.

Or, while aggregation functionality may be implemented, a localized center may be used to efficiently and easily find the best-cost solutions. In the context of an insurance sale to small businesses, the typical parameters used in the formation of a bid from a provider to an end-customer uses such things as company size, zip code, and Standard Industry Classification Code (SIC).

Typically, an insurance provider uses these parameters to generate a bid. However, the scope of access to the bid generation mechanisms is not easy and may take some time.

With these considerations, online business presences suffer from a lack of cohesion in the implementation of these functions of hosting, connectivity, and providing remote application services aggregation support. There are associated costs to providing the infrastructure needed to develop, maintain, improve, and update an Internet or other connectivity solutions implementing a plurality of the previously mentioned functionalities. Most of these small companies cannot absorb these costs, both in monetary or in effort expanded in building and maintaining this infrastructure.

However, in order to meet the challenge of attracting and retaining employees necessary to their business, a small business owner often feels compelled to provide such functionality in a connected environment. Thus, presently, providing a company Intranet is a cost/benefit decision for the small business owner, and a large downside looms if the owner decides wrong in either case.

Aggregating goods and services is beneficial and provides an end-user with a variety of choices and prices from which to select goods and services. Such services that can be aggregated and bid upon include: employee benefit packages, financial packages, direct marketing packages, and other types of goods and services similar to those mentioned.

In the case of employee benefits, a small business owner has a challenge to adequately provide a complete employee benefit package for their employees. Again, the talent necessary to a successful small business demands these packages.

Once again, the small entity operator faces another conundrum. The small entity operator usually does not have the resources to adequately track and maintain various aspects of benefits coverage's, such as COBRA deadlines and the like.

Additionally, many benefits packages may offer constant dollar plans versus the traditional constant plan across workers. When the employer offers a menu style plan with constant dollars with which the employee may pick and choose various options instead of a constant plan across all workers, additional time and effort must be expended to coordinate the employee's choices among these options.

This problem occurs with the choosing of retirement options as well. In this case, the employer is tasked with coordinating the various options among the employees. Additionally, the small business owner must perform several ministerial duties when an employee is hired with respect to these plans, and once again when the employee is no longer in the service of the employer. These activities expend valuable resources and manpower.

Often, the owner is not able to employ dedicated human resources management personnel to oversee management of these types of benefits programs. Thus, once again, the owner must choose between the cost of running a complex employee benefits package through a business, hire a specialist, or not provide the proper package.

Presently, the small business owner is able to obtain small group employee benefits through licensed insurance brokers, who assist the owner in obtaining and managing the proper package for the owner. However, one of the disadvantages with the present system has been the inability of the broker/owner to react rapidly to the change in the owner's employee landscape.

In the case of a broker, it is often desirable to obtain bids from as many providers and of as many different types of services packages as possible. This is true in the case of financial packages as well as other employee benefits, such as insurance. In the case of employee benefits such as insurance, a small broker typically obtains information through visiting a client directly at their place of business. The broker must then submit several bids to various insurance providers. When done in longhand, this may take several days or even weeks to complete. In that timeframe, the landscape for the small business may have changed by adding or deleting employees, or redefining the scope of packages wanted.

Even when the information may be available electronically, each insurance carrier might have its own communications protocol, thus, requiring the broker to maintain a complex system to adequately interface with each individual carrier so that the broker can access each carrier's information. Thus, such commission-based businesses are currently faced with competing problems of providing rapid information to their end customer, providing the infrastructure necessary to do so, but not having the necessary funds or customer base to support such a system.

Both the brokers and the customer face this vexing problem. The customer, in particular, wants the personalized service that a broker system offers in contrast to an impersonal web based system. However, because of the broker's and customer's size, neither is able to present enough market position to force the seller to provide a specialized customer service representative within the framework.

Further, many typical mechanisms do not allow for direct transmission of information regarding the services or goods from individual employees to either the company personnel targeted with the responsibilities of overseeing such benefits, the broker responsible for such benefits package, and the carriers for each benefits package. Additionally, in the case of insurance benefits packages, the carrier typically has no means of reaching the individual users of the packages on an expedited or real-time basis on such matters as available doctors and available plans. The responsibility of disseminating such information is usually left to an administrator in charge of such programs.

For aggregation purposes, a small business cannot offer its employees the advantages found in larger organizations with respect to bargains and discounts available to the larger entities. The smaller entity simply can't match the sheer consumer power of larger entities when approaching outside vendors for bulk rate deals.

As shown, interconnected solutions help many of these problems, but present still others in their implementation. Many other problems and disadvantages of the prior art will become apparent to one skilled in the art after comparing such prior art with the present invention as described herein.

### SUMMARY OF THE INVENTION

Aspects of the invention are found in a hub based networking solution that ties together many aspects of small business functionality. A top-level hub allows communication to brokers of goods and services. The brokers may utilize this meeting area to gain quotes from many different providers of goods and services, and can communicate the quotes for these items to their clients on an expedited basis.

The network center also allows the brokers to maintain a presence on an interconnected network. The brokers may utilize a predefined hierarchy of pages to define their web presence. Or, the brokers may remove, add, or change the pages, thus creating a personalized network storefront for the brokers.

The network center also maintains a secure network system for employees of the brokers. Each broker has its own defined network defined at the remotely located network center, within which the employees may communicate with themselves. Further, the broker can offer its employees access to various ASP modules, such as planners, file organizers, file storage utilities, and contact lists, that the individual employees may access and use.

In this manner, the network center provides an aggregation center for the brokers, and provides for the network presence of the broker. It also provides for the interconnected functionalities between the employees enjoyed by larger entities.

Other aspects may be found when the employees found within the hub system are aggregated for other purposes. This includes the aggregation for receiving discounts from other online vendors and such.

Still further aspects may be found in the invention when each broker hub in turn “hosts” its clients in the system. This allows the clients to enjoy the web hosting, the intranet functionality, and the ASP functionality enjoyed by the broker and its employees. On this level, the broker may make available to the clients the various forms and data necessary for the broker to maintain their business relationship with the client.

Still further, other aspects are found when the client employees further populate the network center's ability to aggregate persons. As explained above, this further enhances the ability of the population of the entire hub to enjoy discounts from third party service and goods providers.

Other aspects are found when the providers from whom the broker solicits bids from are included as other offsetting hubs. This allows the communication of data and information to and from the necessary individuals up and down the information chain created by the “hubbed by level” approach. When the data and/or forms provided to the client employees are relayed from a client employee, that information may be automatically routed to appropriate individuals or storage areas within the client organization, the broker, or even the end provider.

Other aspects, advantages and novel features of the present invention will become apparent from the detailed description of the invention when considered in conjunction with the accompanying drawings.

### BRIEF DESCRIPTION OF THE DRAWINGS

FIG. 1 is a schematic diagram of a modifiable hub-to-hub business device according to the invention.

FIG. 2 is a schematic block diagram of a central service platform according to FIG. 1.

FIG. 3 is an inheritance diagram allowing for a rapid home site to be provided for a broker or a company as indicated with respect to FIGS. 1 and 2.

FIG. 4 is a diagram illustrating the relationship between the previous sections contained within the central service platform of FIG. 1.

FIG. 5 is an expanded schematic diagram of the relationship between the central service platform operator, the brokers, and their associated companies.

### DETAILED DESCRIPTION

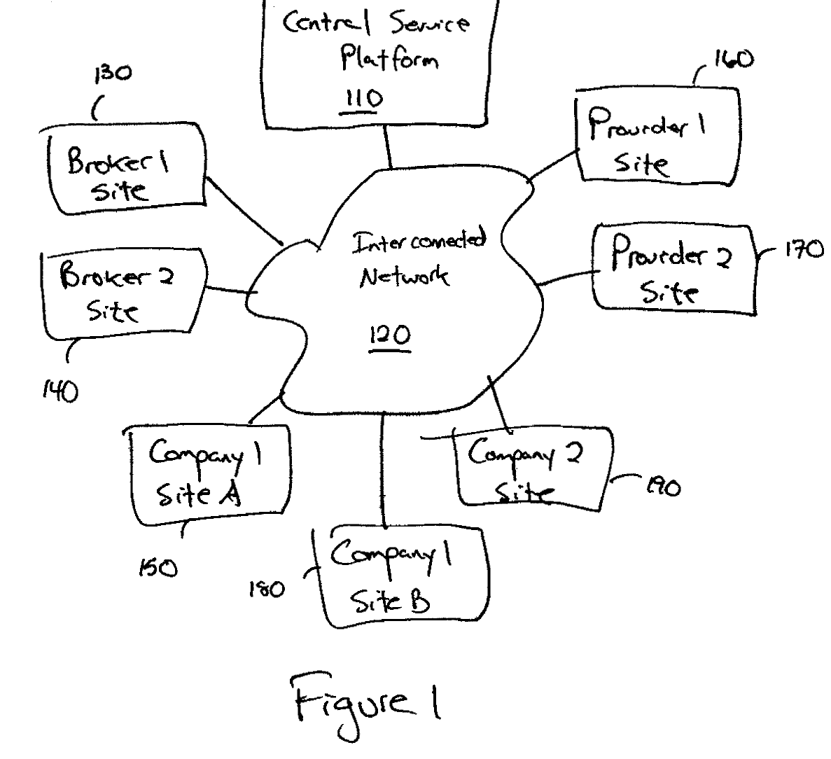

FIG. 1 is a schematic diagram of a modifiable hub-to-hub business device according to the invention. A central service platform 110 is communicatively coupled to an interconnected network 120. The interconnected network may be exemplified by such systems in what is commonly known as the Internet. The central service platform 110 is communicatively coupled to a number of client sites through the interconnected network 120.

For example, the central service platform 110 is communicatively coupled to a provider 1 site 160 and a provider 2 site 170 through the interconnected network 120. In this manner, the provider sites may supply information to the central service platform 110.

At the central service platform 110 the information supplied by the providers may be aggregated for further distribution or action. Or quotes may be sent out in response to any bids from the chained network configuration. In this manner, the organization running the central service platform may use information provided from the provider 1 and/or provider 2 to provide bids to brokers and companies wanting to do business with the provider(s), or collect information on potential transactions.

The central service platform 110 is communicatively coupled to a broker 1 site 130 and a broker 2 site 140. Through the connections to the broker sites, the persons associated with the broker 1 site 130 and the broker 2 site 140 may solicit bids for provider quotes from the particular clients of broker 1 and broker 2. The specific information regarding the possible bids from the providers may be maintained in the central service platform 110.

Or, the central service platform may contain specialized algorithms obtained from the provider 1 site or the provider 2 site. The broker may obtain the relevant information on the particular bid and transmit it to the central service platform 110. There, the information is processed through modules provided by the providers, or based upon information supplied by the providers. In one aspect, the central service platform 110 may request the specific modules from the provider 1 site 160 or the provider 2 site 170, and perform the bid making process based upon the results of the requested and transmitted modules. The quotes resulting from the bids may then be transmitted back to the provider 1 site 160 or the provider 2 site 170, as the case may be.

In this manner, the broker may utilize the aggregation and communication aspects of an interconnected network, such as the Internet, to submit the pertinent information on a real-time basis, and receive a full range of quotes from several service providers through the aggregation and communication mechanism. In this manner, the delay in receiving quotes is cut from weeks to potentially hours or minutes. Or, the bidding function from the broker 1 site 130 or the broker 2 site 140 may be sent as a request through the interconnected network 120 to the central service platform 110. A central service platform 110 may then reformat such information for a quote request and resubmit that information to the provider 1 site 160 and/or the provider 2 site 170 through the interconnected network 120.

The information is processed in the provider 1 site 160 and the provider 2 site 170 and relayed back to the central service platform 110. There, the central service platform 110 relays the quote results corresponding to the information provided the brokers. In this manner the central service platform 110 may serve as an aggregation site for online distribution of goods and/or services from one or more distributors. The aggregation may consist of collecting and sorting bids from these distributors. Also, a formatted presentation may be sent to the broker detailing the various aspects of the returned quotes.

Upon selecting a particular quote, the broker may simply print the application and send it by conventional delivery means. Or, the particular client may indicate its assent electronically through communication to the central service platform 110 and thus to the proper provider site.

Additionally, Company 1 has a site A and site B. The separate sites are denoted as the items 150 and 180, indicating that the sites are remote from one another. These sites are communicatively coupled to the interconnected network 120 and as such to the central service platform 110. These company 1 sites 150 and 180 may be logically linked to an associated broker site from which they receive goods or services. In this manner, Company 1 would be a client of such a broker.

The central network platform 110 performs these aggregation services, and can also act as a network surrogate for communication between the two remote sites, as well as within a site. In this manner, expensive equipment such as routers or switches need not be employed in the various sites.

The central network platform can also provide ASP functionality to all of the employees of the Company 1 through the network connection 120. Again, this allows Company 1 to refrain from purchasing hardware or software to perform these functions.

Still yet, the central network server 10 can house a web site for Company 1. Requests from outside Company 1 for the web site and associated pages are made to the central server platform 110. The central server platform can host predefined websites, or allow the client to modify, overlay, add, or delete specific information or whole pages. Thus, the central server 110 acts as a quote aggregator that allows connectivity between the client, the broker, and the provider, allows the client and broker to maintain a network presence, supplies network based applications to the broker and client employees, and acts as secure intranet for each entity.

In this manner, each of the associated ancillary sites of the provider broker and company need not have extraneous software or hardware associated with them. In fact, the only hardware and software support needed at each one of the ancillary sites is a means for coupling to the interconnected network 120. This may be through any common connection, such as a cable, phone, wireless, or optical connection. The connection can either be a direct link to the central server 110 or the ancillary site could link indirectly through a local Internet Service Provider (ISP) account and access these functionalities through secure connections or locations on the central server 90. In this manner, the central service platform 110 performs all the inter-related functionality, as well as the individual functionality for each of the ancillary sites.

It should be noted that the central service platform 110 is depicted as a single block. However the central service platform 110 need not be restricted to one machine, computing device, or server. In this manner, the central service platform 110 may be thought of as either a single stand alone computing device or server device, or may be a bank of such devices located at different points spaced apart from one another.

As noted above, in addition to performing the aggregation functions and the information downloading and uploading functions between the entities in the diagram, the central service platform 110 may also provide each individual provider, broker, or company with their own personalized hosted web page and/or secure intranet functionality. With such a secure intranet functionality, the individuals located at Company 1 site B 160 may communicate securely with those employees at Company 1 site A 150. In this manner, the Company 1 need not provide additional hardware and software support for the backbone connectivity functionality.

Again, as noted before, the central service platform may also provide functionality at an individual level with each of the ancillary sites depicted in FIG. 1. For example, assume that company 1 has employee A, employee B and employee C. The central service platform 110 may also provide such remote functionalities as financial connectivity for equity trading, financial information for informational purposes such as credit card balances, bank balances, and other types of financial information. This applies to each individual employee on an individual basis.

The central service platform 110 may provide to employee A, employee B, and employee C other such remote functionalities such as personalized internet mail, instant messaging, either in a restricted, secure sense among the common employees or within predefined groups, or in a general sense with the general Internet population. The central service platform can also provide remotely hosted document filing and retention systems through storage facilities, calendaring information for personal schedules, entertainment offerings such as comics, horoscopes, movies, sports reports, personal storage facilities for documents or images, or invitation-type services.

These individual functionalities may be aggregated into an employee portal. Such a defined portal also may have an overlay specific to the particular company. In this manner, Company 1 may be able to communicate significant company events to employees or groups of employees through the use of the calendaring system provided in the central service platform 110. The employees may also be sub-grouped within the general employee population. In this manner, mail and information may be disseminated to these sub-groups, as well as generalized broadcasts to the entire employee population.

The central service platform 110 may also provide additional functionality for any associated providers with the system. With this functionality, a provider of services may obtain statistical analyses of their activities on the system and as related to the brokers, the companies, or the individuals associated with such companies.

For example, provider 1 may wish to determine how many bids were submitted by the central service platform 110, versus how many of its bids were accepted and by whom. The providers may also employ the central service platform 110 to transmit directly to the broker, the individuals in charge of the provider services at associated companies, or to the individuals themselves, pertinent information on the particular services or goods that the provider is providing for those brokers, companies, or individuals.

The providers may make available to the brokers, the brokers' employees, the companies, or the companies' employees the various forms needed for the service that the provider is supplying. For example, should the provider be an insurance company, the provider may use the central service platform 110 to ensure that the brokers have the appropriate forms and contact information for connections to the providers' services and goods.

Additionally, the provider may use the central service platform 110 and the associated intranet services for the broker site and for the company site to ensure that the individual company employees have access to the appropriate forms for the conduct of the insurance functions within the company. In this manner an individual may access the forms locally through the provided intranet, and submit them directly to the appropriate individual at the company, the appropriate individual at the broker site, and through to the provider on an expedited basis.

Further, the company may transmit information on the hiring and termination of individuals associated with it. This information is transferred to the central service platform 110, where both broker and provider may automatically provide mechanisms for compliance with applicable rules and regulations. For example, a terminated employee must have an offer of extension of certain insurance benefits subsequent to termination. This is known as a COBRA program. In this manner, when the company terminates such an employee, the broker or provider may automatically generate such COBRA documents for transmission to the employee based upon the information provided by the employee to the company through its intranet. In this manner, important deadlines that may be previously missed by small or inexperienced companies are automatically and conveniently dealt with on a remote basis.

In one scheme, the networked solution may also provide direct billing and payment functionalities among the clients, the providers, the brokers, and the operator of the central service platform 110. For example, payment may be made for a good or service electronically from the client. When the client submits such payments, the electronic payment may be made to the broker, who in turn initiates payment to the provider.

Or, the client may pay the provider directly through electronic means. The central service platform 110 can channel the payment to the provider, or to a section or module on the central service platform 110 dedicated to the provider.

In the case that the payment is channeled to the central service platform 110, a module within the central service platform can allocate payments. One portion of the payment may be directed to the broker, one portion directed to the provider, and another directed to the operator of the central service platform. In this manner, a single payment may be allocated among the parties electronically and seamlessly.

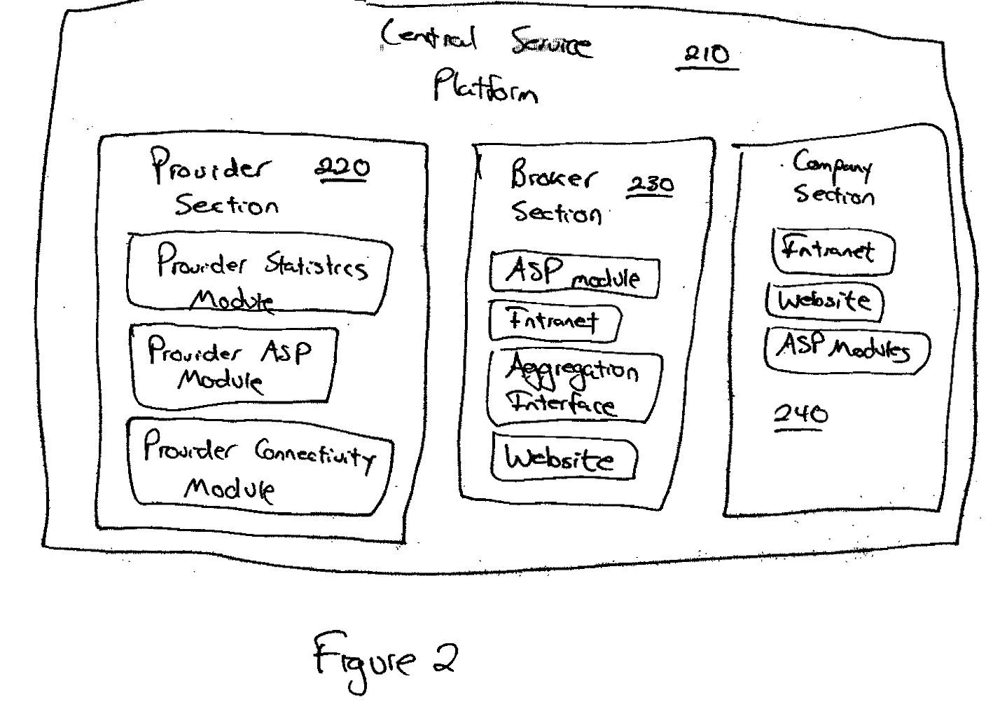

FIG. 2 is a schematic block diagram of a central service platform according to FIG. 1. A central service platform 210 contains several sections. First, a central service platform 210 contains a provider section 220. The provider section 220 may contain such modules as bid module for the provider, or other ASP type application that that provider may wish to use or wish others to use in the context of this invention.

Next, the central service platform 210 contains a broker section 230. The broker section 230 contains access to ASPs that the broker may wish to use or those that it makes available to others, including the bid aggregations from the provider, a secure intranet for its' employees, application services for its employees, such as that described above, as well as a company home site or web page that resides on the central service platform. In this manner the broker may operate a storefront operation in the networked world through the use of the central service platform. In this manner the broker has access to connectivity tools to the provider, aggregation tools that allow it to seek and receive bids on a timely basis from the providers, a secure communication link between its employees, remote applications for use by the employees, and a functional website viewable from the outside world.

The central service platform 210 also has a client section 240. Much like the broker section described above, the company section contains applications suited for use by the client companies of the brokers. The central service platform provides a company intranet for use within the company, a possible company home site such as that provided to a broker, and various applications for use by the company. These ASPs may include such things as scheduling applications, storage applications, communications applications, general information, or broker-specific or provider-specific ASPs when the providers or brokers may initiate transfer of services or conduct of business directly with a company. Additionally, the company section may have direct access to forms provided by the provider and/or broker for easy transmittal to them by the individual employees. In this case, the central service platform provides a scaleable and modifiable kiosk system as well as communications throughput for both the broker and the companies associated with them.

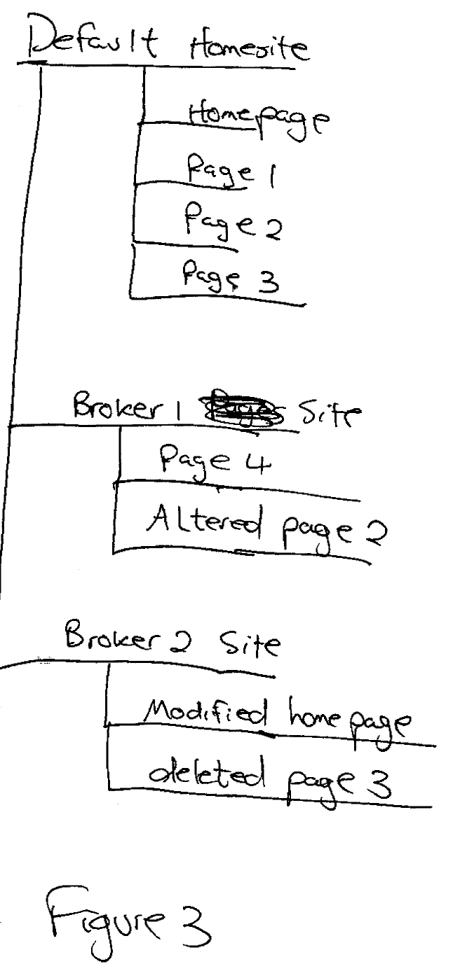

FIG. 3 is an inheritance diagram allowing a home site to be rapidly provided for a broker or a company as indicated with respect to FIGS. 1 and 2. In the embodiment depicted, the central service platform would contain a default broker home site. The default broker home site may contain options for the broker to modify, such as background color and other information specific to that broker, such as name, address, and logos.

Upon initiation of the service through the central service platform, the web address associated with the broker would be directed to the appropriate homepage contained within the central service platform. Upon a request for one of the pages contained within the broker home pages, the central service platform would transmit such a requested universal resource locator (URL) to the requesting device.

Should the broker wish to modify the default, the broker may indicate which pages or information may be deleted or added to the default home site. In this manner the broker may overlay the default home site provided by the central service platform. As such, the broker may construct a brand new website contained within the central service platform, as well as use the pure default. These two conditions exemplify the various extremes that a particular broker may use in the “storefront” home site provided by the central service platform.

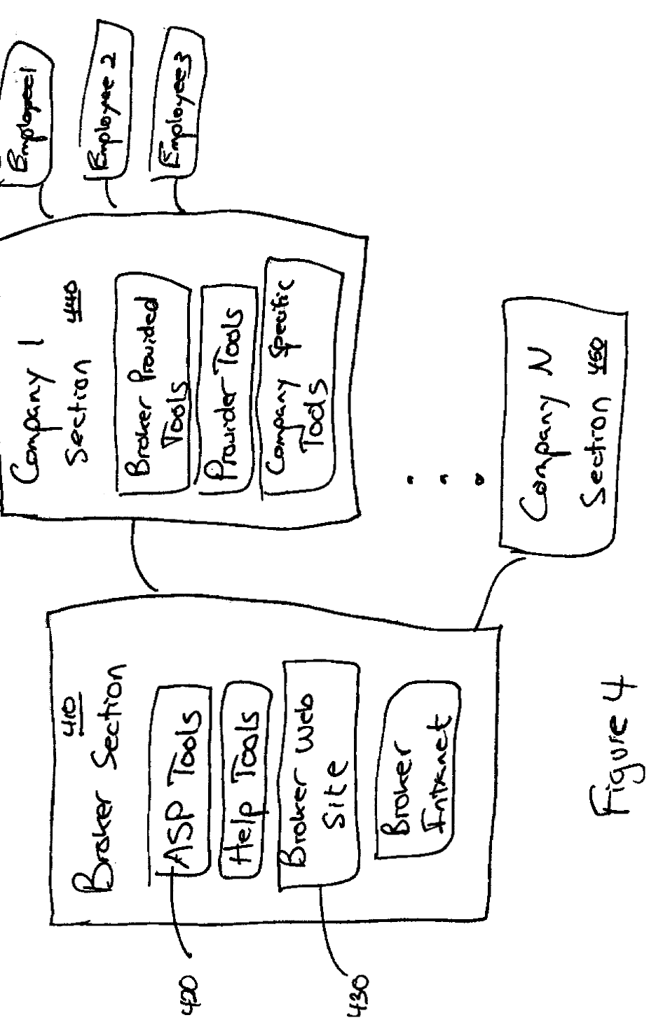

FIG. 4 is a diagram illustrating the relationship between the previous sections contained within the central service platform of FIG. 1. In this figure, a particular broker section 410 contains ASP tools 420 and a broker website 430. The broker section may use the ASP tools in light of its own employees, such as the connectivity and scheduling ASP. Additionally, the employees' broker may be connected by the intranet provided by the central service platform.

In this manner the central service platform provides the business ASP modules and connectivity functionality of a large-scale network server for the broker. It should be noted that numerous brokers are supported, and each broker would contain its own section completely apart and secure from other brokers.

The brokers would be able to offer client companies their modifiable “spokes” from the broker hub. This is depicted as blocks 420 and 430 in FIG. 4. There, the broker, through the central service platform, has provided for the transmission of pertinent information to and from the company, provider tools that allow the company to transmit pertinent information to and from the associated provider, and other company specific tools. The company specific tools include an intranet internal to the Company 1, and functional ASP modules such as calendars, financial quotes, and others like those mentioned above. As such, the Company 1 may offer employee 1, employee 2, and employee 3, their own particular connectivity and ASP functions associated with a web presence.

Additionally, the broker section would contain provider based ASP tools for “aggregation” and “retrieval” functions. This allows the broker to offer the company various services and products through the use of the modifiable hub-to-hub network as described.

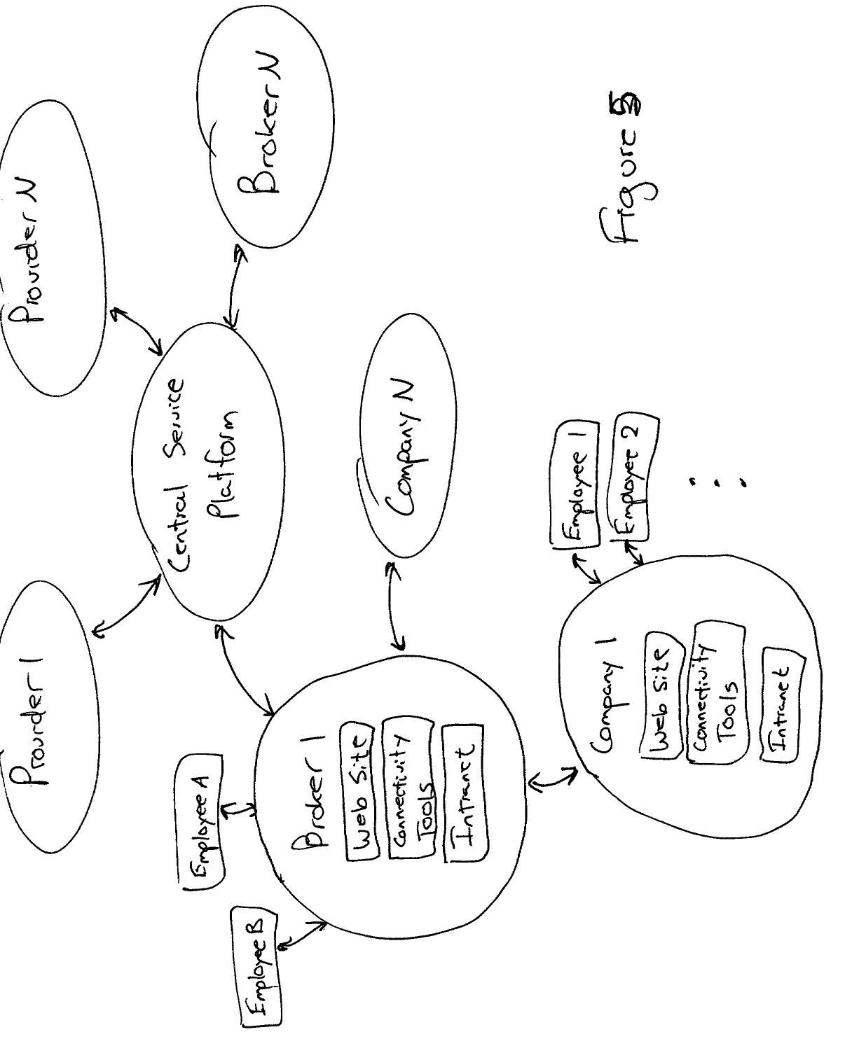

FIG. 5 is an expanded schematic diagram of the relationship between the central service platform operator, the brokers, and their associated companies. It should be noted that the central service platform offers the brokers a base from which to operate in a network environment. In a related manner, the brokers may offer associated companies such network related functionality as well. In addition, the staggered level hub and spoke system allows for direct communications between the employees of company 1 and the broker and/or provider, between the company and broker, between Company 1 and provider, or between the broker and provider. In this manner, all forms of information and functionality may be transmitted to lower levels of the existing structure.

It should be noted that the system described might be used in the context of other goods and services as well. As mentioned before, the financial aspects of small businesses, such as 401(k) plans and the like, may be tailored and administered as well. Also, the system may be used at a high level to aggregate individuals and companies for discounting purposes for third party vendors.

In one example, assume that one of the providers is a financial institution, and in another it is a provider of goods and services tailored to individuals. In this case, the centralized system may be used to aggregate consumers in order to reap benefits associated with larger organizations.

In the context of long distance telephone services, these services are typically less costly with a larger pool of insured individuals. The hub system described may be used to aggregate the populations contained within it defined for the purposes of allowing the pooled rate to be enjoyed by all of the population.

Or, typically other types of providers can provide benefits to these larger populations as well. For example, a lending institution may be able to offer automobile credit terms better to the aggregate population than they would with individuals themselves. In this manner, the administration of the top-level tier may be able to offer group type discounts to the population of all the hubs as a whole through the aggregation function inherent in the structure.

Finally, the structure may be adapted to wireless applications as well. In the case of a broker, the broker may have a personal digital assistant (PDA) and travel to a potential client's place of business. The broker enters the pertinent information into the wireless PDA and accesses the bid and quote mechanism as described above. Thus, the broker can access the functional aspects of the structure even when not accessing the network through a physical link.

Further, in a wireless context, the full advantages of aggregation may be used in a commercial environment. Assume that the individual employees have wireless PDAs and perform commercial transactions. In the context of the commercial transaction, information on the employee is transmitted from the wireless device or smart card coupled to the wireless device to the transaction device. Information on the employee's “membership” in the structure is also communicated. In this manner, and instant benefit may be conferred on the employee in the transaction simply due to the fact that the employee is a member of such a structure.

As such, a layered modifiable hub system for transmitting services and information between providers, brokers, customers, and their associated employees is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

We claim:

1. A system for supporting a quote-receiving entity located at a remote location from a central server, the system comprising:
a quote software for delivering a quote for goods or services from a provider to the receiving entity through the central server;
a communications network software operable by the receiving entity, the communications network software allowing individuals at the receiving entity to propagate information among a predetermined number of other individuals at the remote location; and
the communications network software operating on the central server.

2. The system of claim 1, wherein the quote software is a module located on the central server.

3. The system of claim 1 wherein the quote software is located on another computing device; and
the quote is delivered from the another computing device to the central server.

4. The system of claim 1, wherein the quote software is initially resident on a provider server; and
the quote software is resident and operable on the central server after a request by the central server.

5. The system of claim 1, wherein the provider downloads information to the receiving entity through the communications network.

6. The system of claim 1, wherein the provider is a provider of insurance and the quote is a quote for insurance rates.

7. The system of claim 1 wherein the receiving entity is a broker.

8. The system of claim 1 wherein the receiving entity is a consumer of insurance.

9. A system for supporting a quote-receiving entity located at a remote location from a central server, the system comprising
a quote software for delivering a quote for goods or services from a quote-propagating entity to the receiving entity through the central server; and
a communications network software operable by the receiving entity, the communications network software allowing individuals at the receiving entity to propagate information related to the goods and services to a quote propagating entity.

10. The system of claim 9, wherein the quote software is a module located on the central server.

11. The system of claim 9 wherein the quote software is located on another computing device; and
the quote is delivered from the another computing device to the central server.

12. The system of claim 9, wherein the quote software is initially resident on a provider server; and
the quote software is resident and operable on the central server after a request by the central server.

13. The system of claim 9, wherein the provider downloads information to the receiving entity through the communications network.

14. The system of claim 9, wherein the provider is a provider of insurance and the quote is a quote for insurance rates.

15. The system of claim 9 wherein the receiving entity is a broker.

16. The system of claim 9 wherein the receiving entity is a consumer of insurance.
